(19) United States
(12) Patent Application Publication
(10) Pub. No.: US 2009/0191398 A1
(43) Pub. Date: Jul. 30, 2009

(54) MEMBRANES COMPRISING HYDROPHILIC COATINGS

(75) Inventors: David Roger Moore, Albany, NY (US); Ryan Austin Hutchinson, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/409,078

(22) Filed: Mar. 23, 2009

Related U.S. Application Data
(63) Continuation-in-part of application No. 12/275,368, filed on Nov. 21, 2008.
Application No. 12/275,368 is a continuation-in-part of application No. 12/019,973, filed on Jan. 25, 2008.
Application No. 12/019,973 is a continuation-in-part of application No. 12/019,976, filed on Jan. 25, 2008.

(51) Int. Cl. B01D 71/06; C08F 16/06; C08F 8/00; C08F 20/06; B32B 27/08; B01D 69/12

(52) U.S. Cl. 428/315.5; 525/59; 428/304.4; 428/319.7

(57) ABSTRACT

The present invention provides a membrane useful for water purification comprising a porous base membrane and a hydrophilic coating disposed on the porous base membrane. The hydrophilic coating comprises structural units derived from a hydrophilic polymer and structural units derived from a first electron beam reactive group, and structural units derived from a second electron beam reactive group. The hydrophilic polymer has a number average molecular weight of greater than 2500 Daltons and comprises at least two electron beam reactive groups having different structures. The hydrophilic coating is covalently bound to the porous base membrane through structural units derived from the electron beam reactive groups. Also disclosed are processes for forming and employing the membrane.

### CROSS REFERENCE TO RELATED APPLICATIONS

This application is a Continuation-In-Part of U.S. patent application Ser. No. 12/275,368, filed Nov. 21, 2008, which is a Continuation-In-Part of U.S. patent application Ser. Nos. 12/019,973 and 12/019,976, filed Jan. 25, 2008.

### BACKGROUND OF THE INVENTION

The present invention relates to membranes having a permanently hydrophilic surface. In one aspect the invention relates to polymeric derivatives that may be employed to prepare membranes having a hydrophilic surface covalently bound to an underlying base membrane.

Fluoropolymers such as polytetrafluoroethylene (PTFE) and expanded PTFE (ePTFE) are mechanically robust, heat resistant, and chemically inert materials. These advantageous properties are derived in part from the high strength of the carbon-fluorine bond, which is believed to contribute to the outstanding chemical stability observed among fluoropolymers such as polytetrafluoroethylene. Membranes comprising porous fluoropolymers are prized for their chemical inertness and mechanical stability. However, water filtration using fluoropolymer-based membranes can be problematic due to the hydrophobic nature of fluoropolymers generally, and a surface treatment of some sort is typically required in order to render the fluoropolymer membrane sufficiently hydrophilic to be useful in water purification.

A membrane comprising a fluoropolymer may be rendered more hydrophilic by, for example, employing a surface wetting agent. An important limitation to the use of wetting agents is that the wetting effect imparted by them is typically not permanent.

ePTFE membranes may be used for liquid water filtration, but require a surface wetting treatment step to enable water to pass through the membrane. The requirement of a surface wetting treatment step prior to membrane use raises problematic considerations since such membranes must be “prewetted” by membrane manufacturers before shipment to consumers. Surface treated e-poly(tetrafluoroethylene) membranes are subject to a host of risks such as drying out during transit or handling by the consumer with consequent performance degradation of the membrane thereafter. Other undesirable aspects may include economic considerations such as the need for special handling and sealable containers, and increased shipping weight, and the like.

Accordingly, it would be desirable to provide highly stable, chemically inert membranes suitable for water purification having permanently hydrophilic membrane surfaces.

### BRIEF DESCRIPTION OF THE INVENTION

Disclosed herein are various porous membranes. In one embodiment, the membrane comprises a porous base membrane and a hydrophilic coating bonded to the porous base membrane. The hydrophilic coating comprises structural units derived from a hydrophilic polymer composition, and structural units derived from a first electron beam reactive group and a second electron beam reactive group. The hydrophilic polymer comprises at least one hydrophilic polymer having a number average molecular weight of greater than 2500 Daltons and comprises at least one first electron beam reactive group and at least one second electron beam reactive group, wherein said first electron beam reactive group and said second electron beam reactive group have different chemical structures.

In another embodiment, the present invention provides a membrane comprising a porous base membrane comprising a fluoropolymer, and a hydrophilic coating bonded to the porous base membrane. The hydrophilic coating comprises structural units derived from a polyvinyl alcohol, and structural units derived from a first electron beam reactive group and structural units derived from a second electron beam reactive group. The polyvinyl alcohol has a number average molecular weight of greater than 2500 Daltons and comprises at least one first electron beam reactive group and at least one second electron beam reactive group, wherein the first electron beam reactive group and the second electron beam reactive group have different structures.

In yet another embodiment, the present invention provides a membrane comprising a porous base membrane and a hydrophilic coating bonded to the porous base membrane, wherein the porous base membrane comprises expanded polytetrafluoroethylene, and the hydrophilic coating comprises structural units derived from a polyvinyl alcohol and structural units derived from a first electron beam reactive group which is a methacryloyloxy group and a second electron beam reactive group which is a methacryloyloxyethylaminocarbonyloxy group. The polyvinyl alcohol has a number average molecular weight of greater than 2500 Daltons and comprises a first electron beam reactive group, which is a methacryloyloxy group and a second electron beam reactive group, which is a methacryloyloxyethylaminocarbonyloxy group.

In yet another embodiment, the present invention provides a membrane comprising a porous base membrane and a hydrophilic coating comprising structural units derived from a hydrophilic polymer composition and structural units derived from a first electron beam reactive group and a second electron beam reactive group. The hydrophilic polymer composition comprises a first hydrophilic polymer having a number average molecular weight of greater than 2500 Daltons and comprising at least one first electron beam reactive group. The hydrophilic polymer composition also comprises a second hydrophilic polymer having a number average molecular weight of greater than 2500 Daltons and comprising at least one second electron beam reactive group. The first electron beam reactive group and the second electron beam reactive group have different chemical structures.

In yet another embodiment, the present invention provides a hydrophilic polymer having a number average molecular weight of greater than 2500 Daltons comprising at least one first electron beam reactive group and at least one second electron beam reactive group.

In yet another embodiment, the present invention provides a method of making a hydrophilic polymer, said method comprising (a) contacting a hydrophilic polymer precursor comprising a plurality of reactive hydroxy groups with a first electron beam reactive group precursor whereby at least one, but not all, of the reactive hydroxy groups is converted to a first electron beam reactive group in a first intermediate; and (b) contacting said first intermediate with a second electron beam reactive group precursor whereby at least one of the reactive hydroxy groups is converted to a second electron beam reactive group in a product hydrophilic polymer having a number average molecular weight of greater than 2500 Daltons, said hydrophilic polymer comprising at least one first electron beam reactive group and at least one second electron beam reactive group.

The above described and other features are exemplified by the following figures and detailed description.

### DETAILED DESCRIPTION OF THE INVENTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein, the term “solvent” can refer to a single solvent or a mixture of solvents.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value.

As noted, in one embodiment, the present invention provides a membrane useful in fluid purification. The membranes provided by the present invention comprise a porous base membrane and a hydrophilic coating bonded to the porous base membrane. The hydrophilic coating is derived from a hydrophilic polymer composition comprising a hydrophilic polymer having a number average molecular weight of greater than 2500 Daltons and comprising a first electron beam reactive group and a second electron beam reactive group wherein the first and second electron beam reactive groups have different structures. The hydrophilic polymer composition comprising the electron beam reactive groups is coated onto the porous base membrane and subsequently irradiated in an electron beam apparatus to form a permanently hydrophilic surface on the porous base membrane. Advantageously, the composition can be used to form a permanently hydrophilic porous membrane that exhibits high water flow, low extractables, and robust stability during autoclaving. As used herein, a permanently hydrophilic porous membrane is defined as a membrane which over the course of its useful life does not require a wetting step before use. The membranes provided by the present invention are characterized by excellent wettability, consistent flow rates, and very low or no loss of membrane material due to extraction over multiple wet-dry cycles and/or repeated steam sterilization cycles (autoclave cycles).

In one embodiment, the porous base membrane comprises a fluoropolymer, for example ePTFE. Fluoropolymers are widely available commercially and are known by those of ordinary skill in the art to be mechanically robust, thermally stable, and chemically inert materials. Despite the strength of the carbon-fluorine bond, it is postulated that during irradiation in an e-beam apparatus, a sufficient number of carbon-fluorine bonds are cleaved to form reactive species which enable the hydrophilic polymer composition to be grafted onto the porous base membrane. Because the hydrophilic polymer composition becomes covalently bound to the porous base membrane there is little if any loss of the hydrophilic coating after curing. It is also believed that because of the presence of the first and second electron beam reactive groups, the hydrophilic polymer composition forms a hydrophilic interpenetrating polymer network in intimate contact with the porous base membrane. Regardless of the structure of the hydrophilic coating on the porous base membrane which actually results from e-beam irradiation of the porous base membrane coated with the hydrophilic polymer composition, the present invention provides membranes which are remarkable in that they exhibit essentially permanent wettability. Thus, the claims of the present invention should not be interpreted as limited to membranes in which the hydrophilic coating is covalently bound to the porous base membrane and/or membranes in which the hydrophilic coating is a hydrophilic interpenetrating network polymer. Rather the membranes provided by the present invention are those which are formed when a hydrophilic polymer composition as defined herein in contact with a porous base membrane is irradiated with an electron beam as a means of curing the hydrophilic polymer composition while in contact with the porous base membrane to provide a cured hydrophilic coating in intimate contact with the porous base membrane. As used herein, the term hydrophilic polymer composition refers to an uncured polymer composition comprising electron beam reactive groups which upon exposure to e-beam radiation affords a cured hydrophilic coating in which a substantial portion of the electron beam reactive groups have been converted to other structural units comprising a portion of the hydrophilic coating.

In one embodiment, an initially hydrophobic base membrane may be converted into a permanently hydrophilic membrane of the present invention using the methods and teachings presented herein. Thus, a hydrophobic porous base membrane comprising ePTFE may be coated with a hydrophilic polymer composition comprising at least one first electron beam reactive group and at least one second electron beam reactive group. The resultant uncured coated membrane is then irradiated in an e-beam apparatus thereby producing a hydrophilic coating permanently bound to the hydrophobic porous base membrane. Irradiation of the uncured coated membrane is thought to result in the formation of an interpenetrating polymer network on the porous base membrane and/or the formation of covalent bonds between the porous base membrane and the hydrophilic coating. Because the electron beam reactive groups are transformed into other product structures during the irradiation step, the resultant hydrophilic coating on the porous base membrane is said to comprise structural units derived from the first electron beam reactive group and structural units derived from the second electron beam reactive group. In addition, because the hydrophilic polymer composition is believed to be transformed into a product interpenetrating network polymer as a result of being irradiated in the e-beam apparatus, the hydrophilic coating is said to comprise structural units derived from the hydrophilic polymer composition.

As used herein, the term “porous base membrane” refers to a porous uncoated membrane, while the term “membrane” refers to a membrane that comprises an embodiment of the disclosure, unless language or context indicates otherwise.

Various materials can be used as the porous base membrane. The porous base membrane is said to be “porous” because it comprises an open pore structure. Fluoropolymers which may be used as the porous base membrane include, without limitation, ePTFE, polyvinylidene difluoride (PVDF), poly(tetrafluoroethylene-co-hexafluoropropylene (FEP), poly(ethylene-alt-tetrafluoroethylene) (ETFE), polychlorotrifluoroethylene (PCTFE), poly(tetrafluoroethylene-co-perfluoropropyl vinyl ether) (PFA), poly(vinylidene fluoride-co-hexafluoropropylene (PVDF-co-HFP), and polyvinyl fluoride (PVF). Other materials and methods can be used to form the porous base membrane having an open pore structure and include one or more of polyolefins (e.g., polyethylene, polypropylene, polymethylpentene, polystyrene, substituted polystyrenes, poly(vinyl chloride) (PVC), polyacrylonitriles), polyamide, polyester, polysulfone, polyether, acrylic and methacrylic polymers, polystyrene, polyurethane, polycarbonates, polyesters (e.g., polyethylene terephthalic ester, polybutylene terephthalic ester), polyether sulfones, polypropylene, polyethylene, polyphenylene sulfone, cellulosic polymer, polyphenylene oxide, polyamides (e.g., nylon, polyphenylene terephthalamide), and combinations of two or more of the foregoing polymers.

The porous base membrane may be rendered permeable by, for example, one or more of perforating, stretching, expanding, bubbling, or extracting the base membrane. Suitable methods of making the membrane also may include foaming, skiving or casting any suitable material disclosed herein or otherwise known to those of ordinary skill in the art. In alternate embodiments, the membrane may be formed from woven or non-woven fibers.

In one embodiment, the porous base membrane has a porosity of greater than about 10 percent by volume. In another embodiment, the porous base membrane has a porosity of from about 10 percent to about 20 percent. In yet another embodiment, the porous base membrane has a porosity of from about 20 percent to about 30 percent. In yet another embodiment, the porous base membrane has a porosity of from about 30 percent to about 40 percent. In still yet another embodiment, the porous base membrane has a porosity of from about 40 percent to about 50 percent. In yet another embodiment, the porous base membrane has a porosity of from about 50 percent to about 60 percent. In yet another embodiment, the porous base membrane has a porosity of from about 60 percent to about 70 percent. In yet another embodiment, the porous base membrane has a porosity of from about 70 percent to about 80 percent. In yet another embodiment, the porous base membrane has a porosity of from about 80 percent to about 90 percent. In one embodiment, the porous base membrane has a porosity of greater than about 90 percent by volume. Here and throughout the specification and claims, range limitations may be combined and/or interchanged. Such ranges are identified by their range limitations, and include all the sub-ranges contained therein unless context or language indicates otherwise.

The porous base membrane is characterized by a pore diameter which may be may be uniform or non uniform. In one embodiment, the pores may define a regular pattern. Alternatively, the pores may define an irregular pattern. In one embodiment, the porous base membrane is characterized by a pore diameter of less than about 50 micrometers. In an alternate embodiment, the porous base membrane is characterized by an average pore diameter in a range of from about 50 micrometers to about 40 micrometers. In another embodiment, the porous base membrane is characterized by an average pore diameter in a range of from about 40 micrometers to about 30 micrometers. In another embodiment, the porous base membrane is characterized by an average pore diameter in a range of from about 30 micrometers to about 20 micrometers. In another embodiment, the porous base membrane is characterized by an average pore diameter in a range of from about 20 micrometers to about 10 micrometers. In another embodiment, the porous base membrane is characterized by an average pore diameter in a range of from about 10 micrometers to about 1 micrometers.

In one embodiment, the porous base membrane is characterized by an average pore diameter of less than about 1 micrometer. In another embodiment, the porous base membrane is characterized by an average pore diameter in a range of from about 1 micrometer to about 0.5 micrometers. In another embodiment, the porous base membrane is characterized by an average pore diameter in a range of from about 0.5 micrometer to about 0.25 micrometers. In another embodiment, the porous base membrane is characterized by an average pore diameter in a range of from about 0.25 micrometer to about 0.1 micrometers. In yet another embodiment, the porous base membrane is characterized by average pore diameter of less than about 0.1 micrometers. In yet another embodiment, the porous base membrane is characterized by average pore diameter in a range of from about 0.1 micrometers to about 0.01 micrometers.

In one embodiment, the porous base membrane may be a three-dimensional matrix. In one embodiment, the porous base membrane has a lattice type structure which includes a plurality of nodes interconnected by a plurality of fibrils. Surfaces of the nodes and fibrils may define a plurality of pores in the membrane. In one embodiment, the size of a fibril that has been at least partially sintered is in a range from about 0.05 micrometers to about 0.5 micrometers in diameter taken in a direction normal to the longitudinal extent of the fibril. In one embodiment, the porous base membrane is characterized by a specific surface area in a range from about 0.5 square meters per gram of porous base membrane material to about 110 square meters per gram of porous base membrane material.

Surfaces of nodes and fibrils may define numerous interconnecting pores that extend through the membrane between opposite major side surfaces in a tortuous path. In one embodiment, the average effective pore size of pores in the porous base membrane may be in the micrometer range. A suitable average effective pore size for pores in the membrane may be in a range of from about 0.01 micrometers to about 0.1 micrometers, from about 0.1 micrometers to about 5 microns, from about 5 micrometers to about 10 micrometers, or greater than about 10 micrometers.

In one embodiment, the porous base membrane may be made by extruding a mixture of fine powder particles and lubricant. The extrudate subsequently may be calendared. The calendared extrudate may be “expanded” or stretched in one or more directions, to form fibrils connecting nodes to define a three-dimensional matrix or lattice type of structure. “Expanded” means stretched beyond the elastic limit of the material to introduce permanent set or elongation to fibrils. The porous base membrane may be heated or “sintered” to reduce and minimize residual stress in the porous base membrane material by changing portions of the material from a crystalline state to an amorphous state. In one embodiment, the porous base membrane may be unsintered or partially sintered as is appropriate for the contemplated end use of the porous base membrane.

In one embodiment, the porous base membrane may define many interconnected pores in fluid communication with environments adjacent to the opposite facing major sides of the porous base membrane. The propensity of the material of the porous base membrane to permit a liquid material, for example, an aqueous polar liquid, to wet out and pass through pores may be expressed as a function of one or more properties. The properties may include the surface energy of the membrane, the surface tension of the liquid material, the relative contact angle between the material of the membrane and the liquid material, the size or effective flow area of pores, and the compatibility of the material of the membrane and the liquid material.

As noted, the membranes provided by the present invention may be prepared by coating a porous base membrane with a hydrophilic polymer composition and then curing the coated assembly in an e-beam apparatus. In one embodiment, the hydrophilic polymer composition comprises a polyvinyl alcohol polymer comprising a first electron beam reactive group and a second electron beam reactive group. Suitable polyvinyl alcohol polymers include, without limitation polyvinyl alcohol homopolymers, and polyvinyl alcohol copolymers. In one embodiment, the hydrophilic polymer composition comprises a polyvinyl alcohol-polyvinyl amine copolymer (PVA-PVAm) comprising a first electron beam reactive group and a second electron beam reactive group. Although derivatives of polyvinyl alcohol are especially suitable for the practice of the present invention, other polymeric materials may be used in the hydrophilic polymer composition, including without limitation, polyacrylates, polymethacrylates, polyhydroxyethyl methacrylates, functionalized polyarylenes containing amine, carboxylic acid, amide, hydroxyl moieties, and the like hydrophilic polymers. In one embodiment, the hydrophilic polymer composition used in the preparation of the hydrophilic coating comprises at least one hydrophilic polymer having a number average molecule weight greater than about 2500 Daltons. In another embodiment, the hydrophilic polymer composition used in the preparation of the hydrophilic coating comprises at least one hydrophilic polymer having a number average molecule weight in a range of from greater than 2500 Daltons to about 500,000 Daltons. In yet another embodiment, the hydrophilic polymer composition used in the preparation of the hydrophilic coating comprises at least one hydrophilic polymer having a number average molecule weight in a range of from about 75,000 Daltons to about 250,000 Daltons. Number average molecular weights may be determined by a variety of techniques known to those of ordinary skill in the art including ¹H-NMR spectroscopy and gel permeation chromatography (gpc).

In one embodiment, the membranes provided by the present invention are characterized by a weight percent “add-on” value and a weight percent “burn-off” values, which values can be used to determine the amount of e-beam reactive coating applied to the porous base membrane. In one embodiment, the present invention provides a membrane having a weight percent add-on value in a range of from about 0.5 to about 100 weight percent. In another embodiment, the present invention provides a membrane having a weight percent burn-off value in a range of from about 0.5 to about 100 weight percent. In yet another embodiment, the present invention provides a membrane having a weight percent add-on value and/or a weight percent burn-off value in a range of from about 3 to about 15 weight percent.

As noted, the hydrophilic polymer composition used to prepare the membranes of the present invention comprises a first electron beam reactive group and a second electron beam reactive group which may be attached to the same or different polymers chains within the hydrophilic polymer composition. As will be appreciated by those of ordinary skill in the art a large number of structural types may serve as electron beam reactive groups. The electron beam reactive group is attached to a polymer chain in the hydrophilic polymer composition via a covalent bond. In one embodiment, the first electron beam reactive group and the second electron beam reactive group are attached to a polyvinyl alcohol via a covalent bond formed between a hydroxy group of the polyvinyl alcohol and a suitable first electron beam reactive group precursor and a suitable second electron beam reactive group precursor. An electron beam reactive group is a chemical functional group that is reactive under e-beam conditions. It is believed that under the influence of the e-beam the first and second electron beam reactive groups react to crosslink the hydrophilic polymer composition and to form covalent bonds to the porous base membrane.

A wide variety of electron beam reactive group precursors can be used to attach an electron beam reactive group to the hydrophilic polymer component of the hydrophilic polymer composition, and these electron beam reactive group precursors may be monomers, oligomers, or polymers, or a combination of the foregoing. In one embodiment, the electron beam reactive group is a functional group susceptible to the formation of a free radical under the influence of an e-beam. Those of ordinary skill in the art will appreciate that the structure of a free radical is understood to determine its reactivity and that the structures of the electron beam reactive groups may be selected to provide for a higher or lower level of chemical reactivity of free radicals generated from such electron beam reactive groups under e-beam irradiation. In one embodiment, the electron beam reactive group comprises a functional group capable of forming a secondary or tertiary aliphatic or cycloaliphatic radical. In another alternate embodiment, the electron beam reactive group comprises a functional group capable of forming an aromatic radical, for example a benzyl radical. Other electron beam reactive groups include methacrylates, acrylates, acrylamides, vinylketones, styrenics, vinyl ethers, vinyl groups, allyl groups, benzyl groups, and groups containing tertiary carbon-hydrogen bonds, for example isobutyl groups.

Suitable electron beam reactive group precursors include but are not limited to methacrylates, acrylates and vinyl ketone reagents that can be covalently bound to a hydrophilic polymer. For example, suitable electron beam reactive group precursors include without limitation the reagents acryloyl chloride, (2E)-2-butenoyl chloride, maleic anhydride, 2(5H)-furanone, methyl acrylate, 5,6-dihydro-2H-pyran-2-one, ethyl acrylate, methyl crotonate, allyl acrylate, vinyl crotonate, 2-isocyanatoethyl methacrylate, methacrylic acid, methacrylic anhydride, methacryloyl chloride, glycidyl methacrylate, 2-ethylacryloyl chloride, 3-methylenedihydro-2(3H)-furanone, 3-methyl-2(5H)-furanone, methyl 2-methylacrylate, methyl trans-2-methoxyacrylate, citraconic anhydride, itaconic anhydride, methyl (2E)-2-methyl-2-butenoate, ethyl 2-methylacrylate, ethyl 2-cyanoacrylate, dimethylmaleic anhydride, allyl 2-methylacrylate, ethyl (2E)-2-methyl-2-butenoate, ethyl 2-ethylacrylate, methyl (2E)-2-methyl-2-pentenoate, 2-hydroxyethyl 2-methylacrylate, methyl 2-(1-hydroxyethyl)acrylate, 3-(methacryloyloxy)propyltrimethoxysilane, 3-(diethoxymethylsilyl)propyl methacrylate, 3-(trichlorosilyl)propyl 2-methylacrylate, 3-(trimethoxysilyl)propyl 2-methylacrylate, 3-tris(trimethylsiloxy)silylpropyl methacrylate, 6-dihydro-1H-cyclopenta(c)furan-1,3(4H)-dione, methyl 2-cyano-3-methylcrotonate, trans-2,3-dimethylacrylic acid, and N-(hydroxymethyl)acrylamide.

Suitable vinyl and allyl reagents which may serve as an electron beam reactive group precursor include, without limitation, allyl bromide, allyl chloride, diketene, 5-methylenedihydro-2(3H)-furanone, 3-methylenedihydro-2(3H)-furanone, 2-chloroethyl vinyl ether, and 4-methoxy-2(5H)-furanone.

Suitable isocyanate reagents which may serve as an electron beam reactive group precursor include, without limitation, vinyl isocyanate, allyl isocyanate, furfuryl isocyanate, 1-ethyl-4-isocyanatobenzene, 1-ethyl-3-isocyanatobenzene, 1-(isocyanatomethyl)-3-methylbenzene, 1-isocyanato-3,5-dimethylbenzene, 1-bromo-2-isocyanatoethane, (2-isocyanatoethyl)benzene, 1-(isocyanatomethyl)-4-methylbenzene, 1-(isocyanatomethyl)-3-methylbenzene, 1-(isocyanatomethyl)-2-methylbenzene, and the like.

Suitable styrenic reagents which may serve as an electron beam reactive group precursor include, without limitation, 3-vinylbenzaldehyde, 4-vinylbenzaldehyde, 4-vinylbenzyl chloride, trans-cinnamoyl chloride, phenylmaleic anhydride, 4-hydroxy-3-phenyl-2(5H)-furanone, and the like.

Suitable epoxide reagents which may serve as an electron beam reactive group precursor include, without limitation, glycidyl methacrylate, glycidyl vinyl ether, 2-(3-butenyl)oxirane, 3-vinyl-7-oxabicyclo[4.1.0]heptane, limonene oxide, and the like.

Equations 1-7 below illustrate the preparation of hydrophilic polymers comprising electron beam reactive group, the hydrophilic polymers having the idealized structures shown. Equations 1-3 and 5 illustrate the preparation of derivatized polyvinyl alcohols comprising a single type of electron beam reactive group. Those of ordinary skill in the art will appreciate that the idealized structures given in equations 1-3 and 5, represent derivatized polyvinyl alcohol polymers comprising one or more electron beam reactive groups but that all such electron beam reactive groups have the same chemical structure. A mixture comprising two or more such derivatized polyvinyl alcohol polymers (for example a 1:1 mixture of PVA-MMA (Equation 1) and PVA-PVAm-mal (Equation 5)) represents a hydrophilic polymer composition comprising a first hydrophilic polymer comprising a first electron beam reactive group (a methacryloyloxyethylaminocarbonyloxy group), and a second hydrophilic polymer comprising a second electron beam reactive group (a maleimidido group having the formula C₄H₂O₂N). Alternatively, the derivatized polyvinyl alcohol polymer having the idealized structure shown in Equation 4 represents a hydrophilic polymer which is a derivatized copolymer of vinyl alcohol and vinyl amine (PVA-PVAm) comprising two structurally distinct electron beam reactive groups; a first electron beam reactive group which is a methacryloyloxyethylurido group, and a second electron beam reactive group which is a methacryloyloxyethylaminocarbonyloxy group. Those of ordinary skill in the art will appreciate that structurally distinct electron beam reactive groups may be derived from the same electron beam reactive group precursor. For example, in Equation 4 a methacryloyloxyethylurido group is formed when an amine group (—NH₂) on the PVA-PVAm copolymer reacts with the electron beam reactive group precursor 2-isocyanatoethyl methacrylate, and a structurally distinct methacryloyloxyethylaminocarbonyloxy group is formed when a hydroxy group on the PVA-PVAm reacts with the same electron beam reactive group precursor (2-isocyanatoethyl methacrylate). This example illustrates the principle that for the purposes of this disclosure and the claims appended hereto, electron beam reactive groups include the linking moiety that that binds the electron beam reactive group to the polymer chain regardless of whether the linking moiety is a part of the electron beam reactive group precursor or the polymer chain being derivatized by the electron beam reactive group precursor. In Equation 4 the first electron beam reactive group, the methacryloyloxyethylurido group, includes as the linking moiety the —NH— linking moiety which was originally part of the PVA-PVAm copolymer as an amino (—NH₂) group. Similarly, the second electron beam reactive group, the methacryloyloxyethylaminocarbonyloxy group, includes as the linking moiety the —O— linking moiety, which was originally part of the PVA-PVAm copolymer as a hydroxy (—OH) group. The first electron beam reactive group and the second electron beam reactive group are said to be structurally distinct, meaning that the two electron beam reactive groups have different chemical structures.

Returning to the preparative methods illustrated in Equations 1-7, it should be noted that the conditions give represent typical reaction conditions but are in no way obligatory or limiting. Thus while specific solvents and catalysts are illustrated the same transformations can be performed using a variety of different solvents and conditions. For example, PVA-MMA may be prepared by reacting PVA with 2-isocyanatoethyl methacrylate in the presence of 4-(dimethylamino)pyridine (DMAP) and DMSO at 45° C. as shown in Equation 1. The product PVA-MMA may be isolated by addition of the product mixture in DMSO to a mixture of isopropanol and diethyl ether As illustrated in Equations 2 and 3, polyvinyl alcohol homopolymer may be reacted with either methacrylic anhydride or glycidyl methacrylate in the presence of the tertiary amine catalyst triethylamine to provide the product derivatized polyvinyl alcohol PVA-MA which comprises one or more methacryloyloxy groups per polyvinyl alcohol polymer chain as an electron beam reactive group. Equation 4, illustrates the reaction of the vinyl alcohol-vinyl amine copolymer PVA-PVAm with 2-isocyanatoethyl methacrylate in THF to afford the derivatized hydrophilic polymer, PVA-PVAm-MMA. Equation 5 illustrates the reaction of PVA-PVAm with maleic anhydride in water to afford the derivatized hydrophilic polymer PVA-PVAm-mal. Additional guidance and information on the preparation of derivatized hydrophilic polymers is provided in the Examples section of this disclosure. In Equations 1-7 below, the variables n, x, y, m, a, b, c, d, and z are provided to indicate the block lengths of structural units comprising an electron beam reactive group or a group reactive with a electron beam reactive group precursor, represented in Equations 1-7 by 2-isocyanatoethyl methacrylate (Equation (1)), methacrylic anhydride (Equation 2), glycidyl methacrylate (Equation 3), and maleic anhydride (Equation 5). Variables x, b, d, and z indicate the block lengths of structural units comprising electron beam reactive groups and are in a range of from 1 to 1000. The variables n, m, a, c, and y indicate the block lengths of structural units comprising reactive groups (hydroxy, amino) either in the hydrophilic polymer precursor (e.g. polyvinyl alcohol), or in a product hydrophilic polymer comprising one or more electron beam reactive groups. Variables n, m, a, c, and y may vary independently and are typically in a range from 1 to about 100,000.

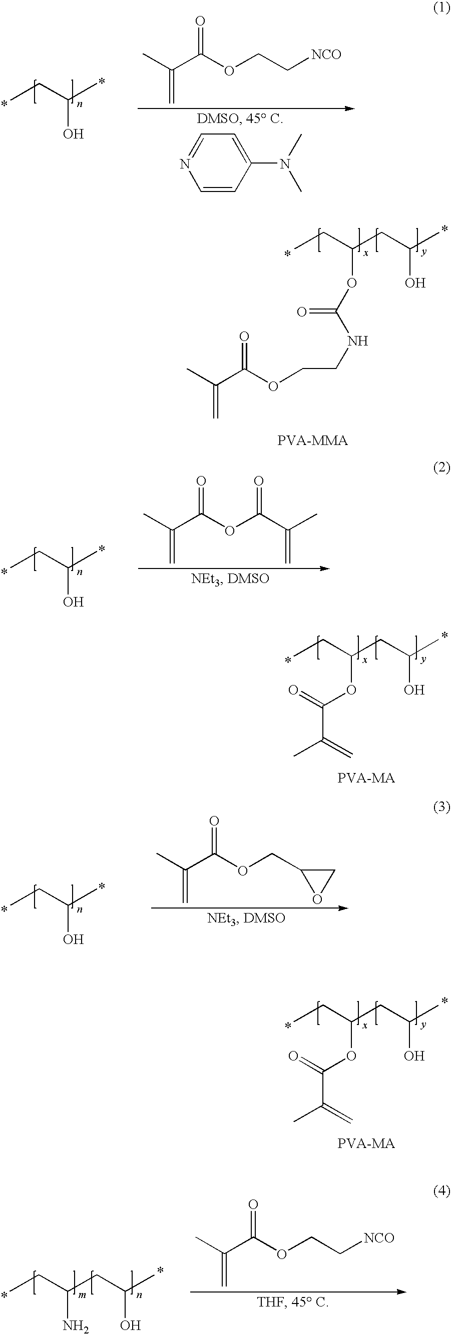

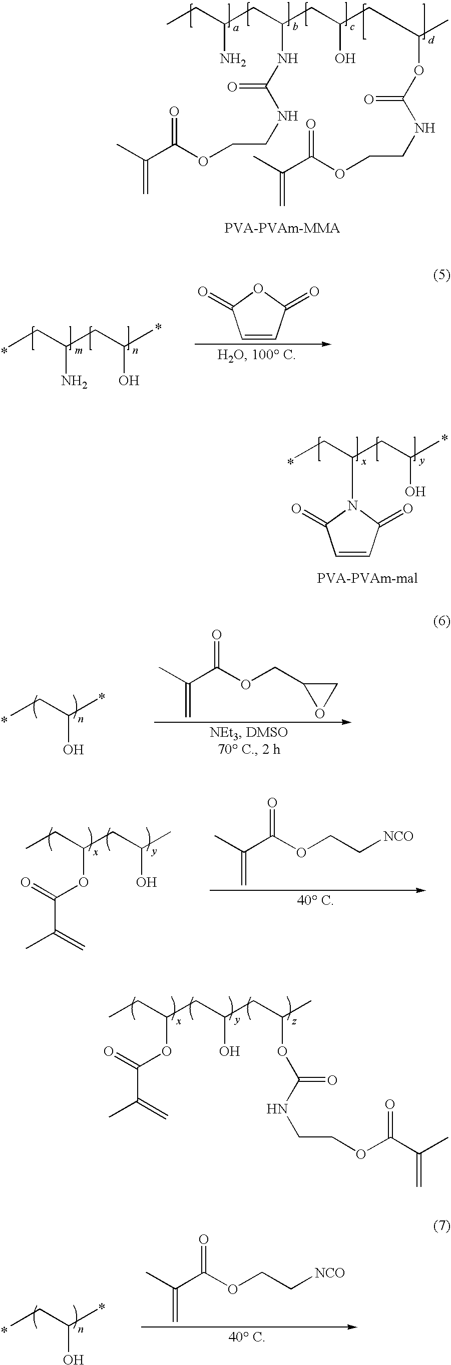

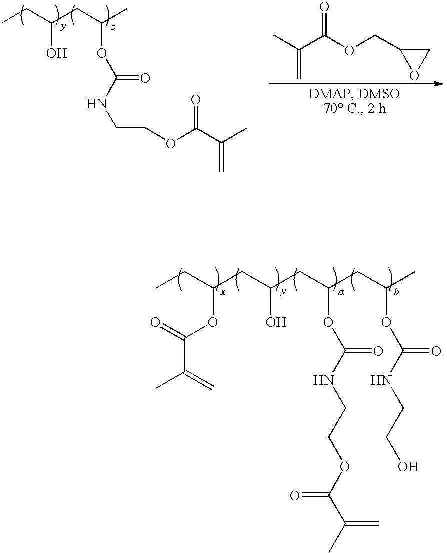

In one aspect, the present invention provides a method for making a membrane with a permanently hydrophilic surface comprising coating a hydrophobic porous base membrane such as an e-poly(tetrafluoroethylene) with a hydrophilic polymer composition comprising at least two electron beam reactive groups which have different chemical structures to provide an uncured coated structure; drying the uncured coated structure under controlled conditions, optionally rewetting the uncured coated structure under controlled conditions, and irradiating the uncured coated structure with an electron beam at a dose between 0.1-2000 kilograys (kGy) in one embodiment, between 1-60 kGy in another embodiment, and between preferably 5-40 kGy in still another embodiment to provide a membrane with a permanently hydrophilic surface. It has been found that the membranes provided by the present invention can be repeatedly autoclaved without loss in hydrophilicity as evidenced by little no membrane weight loss upon extraction in water, repeated water wettability of the membrane, and high water flow rates through the membrane.

In some embodiments, the hydrophobic base membrane is fully wetted during coating to ensure uniform coating deposition of the hydrophilic polymer composition comprising the e-beam reactive groups. Deposition of the hydrophilic polymer composition on the porous base membrane may be carried out by any of a number of art recognized methods such as solution deposition, high pressure solution deposition, vacuum filtration, painting, gravure coating, air brushing, and like polymer deposition techniques. In one embodiment, the hydrophilic polymer composition is dissolved in a solvent such as water or a water-isopropanol mixture and applied to the surface of the porous base membrane.

Once the hydrophilic polymer composition is coated onto the porous base membrane to provide a coated structure, the coated structure is dried to remove water and other volatiles from the coated structure. In one embodiment, the coated structure is dried at a temperature in a range of from about room temperature to about 150° C. In certain embodiments the coated structure may be vacuum dried or air-dried. After drying, the coated structure may be rewetted, for example by spraying with water and/or soaking the coated structure in water.

Electron beam (e-beam) irradiation of the uncured coated structure can be carried out when the uncured coated structure is in either a wet or dry state. Wetting the coating generally includes contacting the uncured coated structure with a solvent capable of swelling the hydrophilic polymer. Suitable solvents include, among others, water, isopropanol, dimethylsulfoxide (DMSO), n-methylpyrrolidone (NMP), dimethyl acetamide (DMAc), and tetrahydrofuran (THF), acetonitrile.

In one embodiment, the present invention provides membrane having permanently hydrophilic surfaces, which also display outstanding resistance to autoclave conditions. Those of ordinary skill in the art will understand that various articles may require sterilization by autoclaving, and that articles such as membranes are frequently hydrolytically sensitive to standard autoclave conditions (steam, 121° C. at 15 psi above atmospheric pressure). The membrane provided by the present invention have been found to be surprisingly robust under standard autoclave conditions and show promise in applications requiring sterilization of the membrane, for example in the preparation of potable water. In one embodiment, the present invention provides a membrane exhibiting outstanding resistance to temperature excursions that can occur during autoclaving.

Membranes according to embodiments of the disclosure may have differing dimensions, some selected with reference to application-specific criteria. In one embodiment, the membrane may have a thickness in the direction of fluid flow in a range of less than about 10 micrometers. In another embodiment, the membrane may have a thickness in the direction of fluid flow in a range of greater than about 10 micrometers, for example, in a range of from about 10 micrometers to about 100 micrometers, from about 100 micrometers to about 1 millimeter, from about 1 millimeter to about 5 millimeters, or greater than about 5 millimeters. In one embodiment, the membrane may be formed from a plurality of differing layers.

In certain embodiments, the membrane may have a width of greater than about 10 millimeters. In one embodiment, the membrane may have a width in a range of from about 10 millimeters to about 45 millimeters, from about 45 millimeters to about 50 millimeters, from about 50 millimeters to about 10 centimeters, from about 10 centimeters to about 100 centimeters, from about 100 centimeters to about 500 centimeters, from about 500 centimeters to about 1 meter, or greater than about 1 meter. The width may be a diameter of a circular area, or may be the distance to the nearest peripheral edge of a polygonal area. In one embodiment, the membrane may be rectangular, having a width in the meter range and an indeterminate length. That is, the membrane may be formed into a roll with the length determined by cutting the membrane at predetermined distances during a continuous formation operation.

Flow rate of fluid through the membranes provided by the present invention may be dependent on one or more factors. The factors may include one or more of the physical and/or chemical properties of the membrane, the properties of the fluid (e.g., viscosity, pH, solute, and the like), environmental properties (e.g., temperature, pressure, and the like), and the like. In one embodiment, the membrane may be permeable to vapor rather than, or in addition to, fluid or liquid. A suitable vapor transmission rate, where present, may be in a range of less than about 1000 grams per square meter per day (g/m²/day), from about 1000 g/m²/day to about 1500 g/m²/day, from about 1500 g/m²/day to about 2000 g/m²/day, or greater than about 2000 g/m²/day. In one embodiment, the membrane may be selectively impermeable to liquid or fluid, while remaining permeable to vapor. In one embodiment, the present invention provides a hydrophilic polymer having a number average molecular weight of greater than 2500 Daltons comprising at least one first electron beam reactive group and at least one second electron beam reactive group. Such hydrophilic polymers may be prepared using the methods disclosed herein, for example by reacting a hydrophilic polymer precursor, for example polyvinyl alcohol having a number average molecular weight of 100000 Daltons with a first electron beam reactive group precursor, for example glycidyl methacrylate to afford a first intermediate comprising reactive hydroxy groups and a first electron beam reactive group which is a methacryloyloxy group. The first intermediate may then be reacted with a second electron beam reactive group precursor, for example acrylic anhydride to afford a product hydrophilic polymer having a molecular weight in excess of 100000 Daltons and comprising a first electron beam reactive group and a second electron beam reactive group.

Thus in one embodiment, the present invention provides a method of making a hydrophilic polymer, said method comprising (a) contacting a hydrophilic polymer precursor comprising a plurality of reactive hydroxy groups with a first electron beam reactive group precursor whereby at least one, but not all, of the reactive hydroxy groups is converted to a first electron beam reactive group in a first intermediate; and (b) contacting said first intermediate with a second electron beam reactive group precursor whereby at least one of the reactive hydroxy groups is converted to a second electron beam reactive group in a product hydrophilic polymer having a number average molecular weight of greater than 2500 Daltons, said hydrophilic polymer comprising at least one first electron beam reactive group and at least one second electron beam reactive group.

The following examples are presented for illustrative purposes only, and are not intended to limit the scope of the invention.

### EXAMPLES

General: Poly(vinyl alcohol) was purchased from Celanese Ltd.; Celvol 165 was used as received, unless otherwise noted. DMSO was purchased from Fisher Scientific and 2-isocyanatoethyl methacrylate was purchased from Aldrich or Monomer-Polymer and Dajac Laboratories, Inc. and used as received. NMR spectra were recorded on a Bruker Avance 400 (1H, 400 MHz) spectrometer and reported chemical shifts are referenced to residual solvent shifts. Vacuum filtration was performed using a 47 mm diameter Millipore glass filter vacuum filtration apparatus. Flow rates of water were performed at 27 inches Hg pressure differential and reported in mL/min-cm². E-beam irradiation experiments were performed with equipment from Advanced Electron Beams Inc. (“AEB”), Wilmington, Mass. Unless otherwise noted, 125 kV was used as a standard voltage (80-150 kV operating voltage range). The e-beam irradiation unit was capable of giving a 50 kGy dose with each pass. Higher dosages were obtained using multiple passes. E-beam dosages were administered from 0 to 100 kGy. All the experiments were done under a nitrogen blanket with oxygen concentration of less than 200 ppm unless otherwise noted. “Extractables” testing was done according to the following procedure. The cured membrane was dried at 70° C. for 1 hour to remove residual volatiles and weighed using a microbalance. The membrane was then confined in mesh screen and soaked in stirred water at 80° C. for 24 hours. The membrane was then dried at 70° C. for 1 hour and weighed using a microbalance. The value reported as “Percent Extractables” was then calculated as the weight percentage difference between the dried samples before and after extraction. Autoclaving was done using a Steris Sterilizer, Amsco Century SV-148H Prevac Steam Sterilizer. Standard autoclaving conditions were 121° C. and 21 psi for 30 minutes.

### Example 1

### Preparation of PVA-UMA(2)-MA(1)

PVA (20.0 g, 454 mmol, Celvol 165 from Celanese Ltd.) and DMSO (235 g) were added to a 500 mL, three-necked round-bottom flask equipped with a mechanical stirrer and stirred vigorously at 70° C. until a homogeneous solution was achieved. A radical inhibitor 2,6-Di-tert-butyl-4-methylphenol (BHT, 10 mg) and triethylamine (0.503 g, 4.97 mmol) were added to the solution of polyvinyl alcohol in DMSO. Glycidyl methacrylate (0.645 g, 4.54 mmol) was then added slowly to the vigorously stirring solution. The viscous solution was stirred for 2 hours at 70° C. and cooled to 40° C. for 4 hours after which time 2-isocyanatoethyl methacrylate (1.40 g, 9.05 mol) was added dropwise over the course of five minutes to the vigorously stirring solution (400 rpm). The resultant viscous solution was stirred for 15 minutes, and then cooled to room temperature. ¹H NMR spectroscopy in DMSO-d₆ showed full conversion of starting materials to product. The product polymer was precipitated into isopropanol (1750 mL total) and the flocculent white solid was collected on a filter and dried under vacuum at room temperature. ¹H NMR showed approximately 2% of the polyvinyl alcohol repeat units had been converted to repeat units comprising the electron beam reactive group urethanoethyl methacrylate (UMA) and approximately 1% of the polyvinyl alcohol repeat units had been converted to repeat units comprising the electron beam reactive group methacrylate (MA). ¹H NMR (DMSO-d₆, 400 MHz) δ 7.21 (2H, bm, NH), 6.07 (2H, bs, CHH═CMe-UMA), 5.99 (1H, bs, CHH═CMe-MA), 5.67 (2H, bs, CHH═CMe-UMA), 5.62 (1H, bs, CHH═CMe-MA), 5.19 (1H, bm, OH of PVA), 4.94 (2H, bm, OH of PVA), 4.68 (20H, bm, OH of PVA), 4.48 (50H, bm, OH of PVA), 4.24 (32H, bm, OH of PVA), 4.07 (4H, bm, CH₂CH₂—UMA), 3.9-3.6 (100H, CH of PVA, 3.25 (4H, bm, CH₂CH₂-UMA), 1.88 (9H, bs, CHH═CMe-UMA+MA), 1.8-1.2 (212H, bm, CH₂ of PVA).

### Example 2

### Preparation of PVA-UMA(1.5)-MA(1.5)

A hydrophilic polymer comprising urethanoethyl methacrylate (UMA) groups as the first electron beam reactive group and methacrylate (MA) groups second electron beam reactive group attached to a polyvinyl alcohol was prepared as in Example 1 using Cevol 165 as the starting polyvinyl alcohol. ¹H NMR showed approximately 1.5% of the polyvinyl alcohol repeat units had been converted to repeat units comprising the electron beam reactive group urethanoethyl methacrylate (UMA) and approximately 1.5% of the polyvinyl alcohol repeat units had been converted to repeat units comprising the electron beam reactive group methacrylate (MA).

### Example 3

### Preparation of PVA-UMA(1.0)-MA(2.0)

A hydrophilic polymer comprising urethanoethyl methacrylate (UMA) groups as the first electron beam reactive group and methacrylate (MA) groups second electron beam reactive group attached to a polyvinyl alcohol was prepared as in Example 1 using Cevol 165 as the starting polyvinyl alcohol. ¹H NMR showed approximately 1.0% of the polyvinyl alcohol repeat units had been converted to repeat units comprising the electron beam reactive group urethanoethyl methacrylate (UMA) and approximately 2.0% of the polyvinyl alcohol repeat units had been converted to repeat units comprising the electron beam reactive group methacrylate (MA).

Method 1 Coating e-PTFE with a Hydrophilic Polymer

The hydrophilic polymer PVA-UMA-MA (2.50 g) was dissolved in deionized water (97.5 g) at 50° C. in a blender with stirring. Isopropanol (100 mL) was slowly added to the stirred solution of the hydrophilic polymer in water. Sufficient isopropanol was evaporated to afford a 1.20 wt % PVA-UMA-MA solution (theoretical wt %=1.25%). A porous base membrane, (BHA ePTFE membrane available through GE Energy-Environmental Services), was wetted out fully in the PVA-UMA-MA solution and excess solution was squeegeed off. The coated ePTFE sample was transparent to a human observer and was mounted in a polypropylene hoop and allowed to air dry. The weight percent add-on values for a series of test samples prepared as described above were determined to be in a range of from about 6 and about 10 wt %.

### Method 2 Electron Beam Treatment

Coated, uncured ePTFE membrane samples comprising one of the hydrophilic polymers disclosed herein were irradiated with an electron beam (e-beam) apparatus. The samples prepared and mounted in polypropylene hoops as described in Method 1 above were sprayed with deionized water until complete “wet out” of the sample was achieved (i.e., The sample appeared completely transparent to a human observer). Excess water was removed from the sample (squeegee and/or Kimwipes®) to ensure that no pooling of water occurred on the sample. The samples were placed in the AEB e-beam apparatus and purged with nitrogen until the oxygen concentration in the e-beam apparatus was less than 200 ppm. At a standard voltage of 125 kV, the wet sample was exposed to the desired dosage to provide a membrane comprising e-PTFE as the porous base membrane and a hydrophilic coating bonded to the porous base membrane. The hydrophilic coating comprises structural units derived from the functionalized polyvinyl alcohol and structural units derived from the first and second e-beam reactive groups of the compositions prepared in Examples 1-3. The hydrophilic coating is permanently bound to the e-PTFE as a result of the e-beam treatment.

### Characterization of Cured Membranes

The cured membranes prepared as described herein were evaluated for weight percent “add-on”, flow rate, wettability following autoclave treatment, and flow rate following autoclave treatment. In each instance the e-beam irradiation dosage and wettability prior to e-beam irradiation are provided for reference. Data are gathered in Table 1 below. The data in Table 1 show, inter alia, that as the mole percent ratio of UMA/MA e-beam reactive groups increases in the PVA-UMA-MA coated ePTFE, those samples comprising a higher proportion of structural units derived from UMA groups show enhanced flow rates after e-beam treatment. Compare, for example, results obtained for PVA-UMA(2)-MA(1) and PVA-UMA(1.5)-MA(1.5) at a dosage of 10 kGy. Autoclave treatment also increases flow rates relative to the cured membrane prior to autoclaving. In addition, wettability after autoclaving was improved with higher UMA/MA ratios. It is noteworthy that the PVA-UMA(2)-MA(1) system showed better wettability both before and after autoclave treatment as compared to PVA-UMA(2.6). Flow rates through cured membranes also increase with increasing e-beam dosage.

TABLE 1
Flow rates and water wettability after e-beam and after autoclave
for functionalized ePTFE samples coated with PVA-UMA-MA.^{a}

| | | | Before | After | After | After |
|---|---|---|---|---|---|---|
| | Wt % Add- | Dosage | E-beam | E-Beam | Autoclave | Autoclave |
| Sample | on^{b} | (kGy) | Wettability^{c} | Flow rate^{d} | Wettability^{c} | Flow rate^{d} |
| PVA-UMA(2.6)^{e} | 8.6% | 5 | 4.0 | 12.2 | 3.75 | 46.6 |
| PVA-UMA(2)-MA(1)^{f} | 5.9% | 5 | 4.5 | 22.5 | 4.5 | 51.6 |
| PVA-UMA(2)-MA(1) | 6.1% | 8 | 4.5 | 27.7 | 4.5 | 72.4 |
| PVA-UMA(2)-MA(1)^{f} | 5.1% | 10 | 4.5 | 36.3 | 4.5 | 78.5 |
| PVA-UMA(2)-MA(1) | 5.8% | 15 | 4.5 | 20.5 | 4.5 | 79.3 |
| PVA-UMA(1.5)-MA(1.5)^{f} | 7.3% | 5 | 4.5 | 10.8 | 3.5 | 46.9 |
| PVA-UMA(1.5)-MA(1.5) | 6.2% | 8 | 4 | 21.5 | 2 | 23.3 |
| PVA-UMA(1.5)-MA(1.5)^{f} | 6.8% | 10 | 4.5 | 16.6 | 4.5 | 70.4 |
| PVA-UMA(1.5)-MA(1.5) | 6.6% | 15 | 4.5 | 28.3 | 4.5 | 81.3 |
| PVA-UMA(1)-MA(2)^{f} | 7.8% | 5 | 4 | 16.0 | 1.5 | 11.6 |
| PVA-UMA(1)-MA(2)^{f} | 6.8% | 10 | 4 | 13.6 | 2.0 | 14.6 |
| PVA-UMA(1)-MA(2) | 6.9% | 15 | 4 | 14.1 | 3.5 | 41.4 |

^{a}ePTFE (GE Energy Part # QM702; Roll 73965-1LB) was coated with a pre-dissolved solution of hydrophilic additive mixed with a 1.2 wt % PVA-UMA-MA solution in 1:1 water:IPA. All samples were wet out with water and then exposed to e-beam irradiation. PVA-UMA(2)-MA(1) corresponds to a PVA derivative with repeat units containing 97 mol % PVA, 2 mol % UMA functionality, and 1 mol % MA functionality.
^{b}Weight percent add-ons are calculated: (membrane weight after coating - membrane weight before coating)/membrane weight before coating.
^{c}Based on a scale of 1 to 5 with 1 meaning completely opaque (no water wettability) and 5 meaning full transparency (complete water wet-out) using visual inspection of water wet-out on membranes.
^{d}DI water flow rates are measured in mL/min-cm² @ 27″ Hg vacuum.
^{e}Average of three samples.
^{f}Average of two samples

In Table 2 flow rates are reported for blends of PVA-UMA(2.5) and PVA-MA(2.5) and compared with control samples of PVA-UMA(2.5) and PVA-MA(2.5). Comparison of blends to the control samples show both improved water flow rate and wettability following autoclave treatment among compositions comprising structural units derived from at least two different types of electron beam reactive group. Higher percentages of PVA-MA(2.5) in the coating composition led to improved wettability before autoclave treatment, but decreased flow rates following autoclave treatment. The best wettability before and after autoclave treatment was observed with the 2:1 PVA-UMA(2.5):PVA-MA(2.5) formulation cured at 15 kGy. It is believed that the use of lower e-beam dosages is preferred since higher than necessary dosages may degrade the mechanical properties of the e-PTFE porous base membrane. Fortunately, even at 5 kGy, good wettability was observed with blends of 2:1 PVA-UMA(2.5):PVA-MA(2.5).

TABLE 2
Flow rates and water wettability after autoclave for functionalized
ePTFE samples coated with blends of PVA-UMA(2.5) and PVA-MA(2.5).^{a}

| | ePTFE | Dosage | After Autoclave | After Autoclave Flow |
|---|---|---|---|---|
| Sample Description | Part # | (kGy) | Wettability^{b} | rate^{c} |
| PVA-MA(2.5) | QM701 | 10 | 2.5 | 28.1 |
| PVA-UMA(2.5) | QM701 | 10 | 4 | 70.4 |
| 1:1 PVA-UMA(2.5):PVA-MA(2.5) | QM702 | 5 | 3.5 | 31.2 |
| 1:1 PVA-UMA(2.5):PVA-MA(2.5) | QM702 | 10 | 4 | 71.2 |
| 2:1 PVA-UMA(2.5):PVA-MA(2.5) | QM701 | 5 | 4 | 50.1 |
| 2:1 PVA-UMA(2.5):PVA-MA(2.5) | QM701 | 10 | 4.5 | 82.3 |
| 2:1 PVA-UMA(2.5):PVA-MA(2.5) | QM701 | 15 | 4.5 | 107.0 |

^{a}ePTFE (GE Energy Part # QM702 - 0.45 micron nominal pore size or QM701 - 1.0 micron nominal pore size) was coated with a pre-dissolved solution of hydrophilic additive mixed with a 1.3 wt % solution in 1:1 water:IPA. All samples were wet out with water and then exposed to e-beam irradiation. PVA-UMA(2.5) corresponds to a PVA derivative with repeat units containing 97.5 mol % PVA and 2.5 mol % UMA functionality.
^{b}Based on a scale of 1 to 5 with 1 meaning completely opaque (no water wettability) and 5 meaning full transparency (complete water wet-out) using visual inspection of water wet-out on membranes.
^{c}DI water flow rates are measured in mL/min-cm² @ 27″ Hg vacuum

Advantageously, the composite compositions as described above can be employed in numerous applications, including but not limited to, liquid filtration, water purification, chemical separations, charged ultrafiltration membranes, protein sequestration/purification, waste treatment membranes, biomedical applications, pervaporation, gas separation, the fuel cell industry, electrolysis, dialysis, cation-exchange resins, batteries, reverse osmosis, dielectrics/capacitors, industrial electrochemistry, SO₂ electrolysis, chloralkali production, and super acid catalysis. As membranes, the composite compositions wet out completely, and demonstrate high fluxes of water and essentially no extractables over many autoclave cycles.

As used herein, the term “comprising” means various compositions, compounds, components, layers, steps and the like can be conjointly employed in the present invention. Accordingly, the term “comprising” encompasses the more restrictive terms “consisting essentially of” and “consisting of.”

Unless defined otherwise, technical and scientific terms used herein have the same meaning as is commonly understood by one of skill in the art to which this invention belongs. The terms “a” and “an” do not denote a limitation of quantity, but rather denote the presence of the referenced item.

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

This written description uses examples to disclose the invention, including the best mode, and also to enable practice of the invention, including making and using any devices or systems and performing any incorporated methods. The patentable scope of the invention is defined by the claims, and may include other examples. Such other examples are intended to be within the scope of the claims if they have structural elements that do not differ from the literal language of the claims, or if they include equivalent structural elements with insubstantial differences from the literal language of the claims.

1. A membrane, comprising:
a porous base membrane; and
a hydrophilic coating bonded to the porous base membrane, wherein the hydrophilic coating comprises structural units derived from a hydrophilic polymer composition, and structural units derived from a first electron beam reactive group and a second electron beam reactive group, wherein the hydrophilic polymer composition comprises at least one hydrophilic polymer having a number average molecular weight of greater than 2500 Daltons and comprising at least one first electron beam reactive group and at least one second electron beam reactive group, and wherein said first electron beam reactive group and said second electron beam reactive group have different chemical structures.

2. The membrane of claim 1, wherein the hydrophilic polymer is a polyvinyl alcohol, a polyvinyl alcohol-polyvinyl amine copolymer, a polyacrylic acid, a polyacrylate, a polyethylene glycol, a polyethylene amine, or a polyvinyl amine.

3. The membrane of claim 1, wherein the porous base membrane comprises polyvinylidene difluoride, poly(tetrafluoroethylene-cohexafluoropropylene, poly(ethylene-alt-tetrafluoroethylene), polychlorotrifluoroethylene, poly(tetrafluoro-ethylene-co-perfluoropropyl vinyl ether), poly(vinylidene fluoride-co-hexafluoro-propylene, polyvinyl fluoride, polytetrafluoroethylene, and combinations of two or more thereof.

4. The membrane of claim 1, wherein at least one of the first or second electron beam reactive groups is selected from the group consisting of methacrylate moieties, acrylate moieties, acrylamide moieties, alpha-beta unsaturated carbonyl moieties, and vinyl moieties.

5. The membrane of claim 1, wherein at least one of first or second electron beam reactive groups is selected from the group consisting of vinylphenyl moieties, vinyl ether moieties, and allyl moieties.

6. The membrane of claim 1, wherein at least one of the first or second electron beam reactive groups is a benzylic moiety, or a moiety comprising a tertiary-carbon-hydrogen bond.

7. The membrane of claim 1, wherein at least one of the first or second electron beam reactive groups is derived from a reagent selected from the group consisting of acryloyl chloride, (2E)-2-butenoyl chloride, maleic anhydride, 2(5H)-furanone, methyl acrylate, 5,6-dihydro-2H-pyran-2-one, ethyl acrylate, methyl crotonate, allyl acrylate, vinyl crotonate, 2-isocyanatoethyl methacrylate, methacrylic acid, methacrylic anhydride, methacryloyl chloride, glycidyl methacrylate, furfuryl methacrylate, 2-ethylacryloyl chloride, 3-methylenedihydro-2(3H)-furanone, 3-methyl-2(5H)-furanone, methyl methylacrylate, methyl trans-2-methoxyacrylate, citraconic anhydride, itaconic anhydride, methyl (2E)-2-methyl-2-butenoate, ethyl 2-methylacrylate, ethyl 2-cyanoacrylate, dimethylmaleic anhydride, allyl 2-methylacrylate, ethyl (2E)-2-methyl-2-butenoate, ethyl 2-ethylacrylate, methyl (2E)-2-methyl-2-pentenoate, 2-hydroxyethyl 2-methylacrylate, methyl 2-(1-hydroxyethyl)acrylate, 6-dihydro-1H-cyclopenta[c]furan-1,3(4H)-dione, trans-cinnamoyl chloride, phenylmaleic anhydride, 4-hydroxy-3-phenyl-2(5H)-furanone, 5-ethyl-3-hydroxy-4-methyl-2(5H)-furanone, 3-methylene-dihydro-2(3H)-furanone, 4-methoxy-2(5H)-furanone, [3-(methacryloyloxy)-propyl]trimethoxysilane, 3-(diethoxymethylsilyl)propyl methacrylate, 3-(trichlorosilyl)propyl 2-methylacrylate, 3-(trimethoxysilyl)propyl 2-methylacrylate, 3-[tris(trimethylsiloxy)silyl]propyl methacrylate, methyl 2-cyano-3-methylcrotonate, trans-2,3-dimethylacrylic acid, N-(hydroxymethyl)acrylamide, and combinations thereof.

8. The membrane of claim 1, wherein at least one of the first or second electron beam reactive groups is derived from a reagent selected from the group consisting of 3-vinylbenzaldehyde, 4-vinylbenzaldehyde, 4-vinylbenzyl chloride, glycidyl vinyl ether, 2-(3-butenyl)oxirane, 3-vinyl-7-oxabicyclo[4.1.0]heptane, or limonene oxide, furfuryl isocyanate, allyl bromide, allyl chloride, diketene, vinyl isocyanate, allyl isocyanate, 5-methylenedihydro-2(3H)-furanone, and 2-chloroethyl vinyl ether.

9. The membrane of claim 1, wherein at least one of the first or second electron beam reactive groups are derived from a reagent selected from the group consisting of 1-ethyl-4-isocyanatobenzene, phenethyl isocyanate, 1-ethyl-3-isocyanatobenzene, 1-(isocyanatomethyl)-3-methylbenzene, 1-isocyanato-3,5-dimethylbenzene, 1-bromo-2-isocyanatoethane, 1-(isocyanatomethyl)-4-methyl-benzene, 1-(isocyanatomethyl)-3-methylbenzene, and 1-(isocyanatomethyl)-2-methylbenzene.

10. The membrane of claim 1, wherein the porous base membrane comprises at least one polymeric material selected from the group consisting of polyethylenes, polyamides, polyesters, polysulfones, polyethers, polyacrylates, polymethacrylates, polystyrenes, polyurethanes, polypropylenes, polyphenylene sulfones, polyphenylene oxides, and cellulosic polymers.

11. The membrane of claim 1, wherein the porous base membrane comprises expanded polytetrafluoroethylene and the hydrophilic polymer is a polyvinyl alcohol.

12. The membrane of claim 11, wherein the polyvinyl alcohol has a number average molecular weight in a range of from greater than 2500 Daltons to about 500,000 Daltons, and wherein the polyvinyl alcohol comprises a first electron beam reactive methacryloyloxy group, and a second electron beam reactive methacryloyloxyethylaminocarbonyloxy group.

13. The membrane of claim 1, wherein the hydrophilic polymer comprises from about 0.1 mol % to about 10 mol % of e-beam reactive groups based on a total number of polymer repeat units present in the hydrophilic polymer.

14. The membrane of claim 1, wherein the hydrophilic coating is covalently linked to the porous base membrane by structural units derived from the electron beam reactive groups.

15. The membrane as defined in claim 1, wherein the hydrophilic coating has an average thickness of from about 1 nanometer to about 1 micrometer.

16. A membrane, comprising:
a porous base membrane comprising a fluoropolymer; and
a hydrophilic coating bonded to the porous base membrane, wherein the hydrophilic coating comprises structural units derived from a polyvinyl alcohol, and structural units derived from a first electron beam reactive group and a second electron beam reactive group, wherein the polyvinyl alcohol has a number average molecular weight of greater than 2500 Daltons and comprises at least one first electron beam reactive group and at least one second electron beam reactive group, and wherein said first electron beam reactive group and said second electron beam reactive group have different chemical structures.

17. The membrane of claim 15 which is characterized by an average pore size of 10 nm to 50 microns.

18. The membrane of claim 15, wherein the fluoropolymer is an expanded polytetrafluoroethylene.

19. A membrane, comprising:
a porous base membrane comprising expanded polytetrafluoroethylene; and
a hydrophilic coating bonded to the porous base membrane, wherein the hydrophilic coating comprises structural units derived from a polyvinyl alcohol, and structural units derived from a first electron beam reactive group and a second electron beam reactive group, wherein the polyvinyl alcohol has an number average molecular weight of greater than 2500 Daltons and comprises a first electron beam reactive methacryloyloxy group, and a second electron beam reactive group methacryloyloxyethylaminocarbonyloxy group.

20. The membrane of claim 19, wherein the polyvinyl alcohol comprises from about 0.1 mol % to about 10 mol % of e-beam reactive groups based on a total number of polyvinyl alcohol repeat units.

21. The membrane of claim 20, wherein the polyvinyl alcohol has a number average molecular weight of from greater than 2500 Daltons to about 500,000 Daltons.

22. A membrane, comprising:
a porous base membrane; and
a hydrophilic coating bonded to the porous base membrane, wherein the hydrophilic coating comprises structural units derived from a hydrophilic polymer composition, and structural units derived from a first electron beam reactive group and a second electron beam reactive group, wherein the hydrophilic polymer composition comprises a first hydrophilic polymer having a number average molecular weight of greater than 2500 Daltons comprising at least one first electron beam reactive group, and wherein the hydrophilic polymer composition comprises a second hydrophilic polymer having a number average molecular weight of greater than 2500 Daltons comprising at least one second electron beam reactive group, wherein said first electron beam reactive group and said second electron beam reactive group have different chemical structures.

23. A hydrophilic polymer having a number average molecular weight of greater than 2500 Daltons comprising at least one first electron beam reactive group and at least one second electron beam reactive group.

24. The composition of claim 23, wherein said hydrophilic polymer is a polyvinyl alcohol.

25. The composition of claim 23, wherein said first electron beam reactive group is a methacryloyloxy group, and said second electron beam reactive group is a methacryloyloxyethylaminocarbonyloxy group.

26. A method of making a hydrophilic polymer, said method comprising:
(a) contacting a hydrophilic polymer precursor comprising a plurality of reactive hydroxy groups with a first electron beam reactive group precursor whereby at least one, but not all, of the reactive hydroxy groups is converted to a first electron beam reactive group in a first intermediate; and
(b) contacting said first intermediate with a second electron beam reactive group precursor whereby at least one of the reactive hydroxy groups is converted to a second electron beam reactive group in a product hydrophilic polymer having a number average molecular weight of greater than 2500 Daltons, said hydrophilic polymer comprising at least one first electron beam reactive group and at least one second electron beam reactive group.
